(19) United States
(12) Patent Application Publication
(10) Pub. No.: US 2014/0104661 A1
(43) Pub. Date: Apr. 17, 2014

(54) Integrated Mobile Printer And Scanner

(71) Applicants: Guangchao Guan, Singapore (SG); Kok Hong Kan, Singapore (SG)

(72) Inventors: Guangchao Guan, Singapore (SG); Jianbin Huang, Shanghai (CN); Kok Hong Kan, Singapore (SG)

(73) Assignee: VENTURE CORPORATION LIMITED, Singapore (SG)

(21) Appl. No.: 13/806,135

(22) PCT Filed: Jun. 22, 2010
(86) PCT No.: PCT/SG2010/000234

§ 371 Date: Jun. 7, 2013

(51) Int. Cl. H04N 1/12

(52) U.S. Cl. CPC H04N 1/1215
USPC 358/498

(57) ABSTRACT

The present invention provides a multi-function device having a housing, a printer module and a scan module. The housing having a plurality of pivotable panels, wherein the pivotable panels are collapsible on the housing to conform with its surfaces thereon. The printer module has a printer head assembly and a multiple sheet feeder disposed within the housing, the multiple sheet feeder having a first paper guide, a feeder assembly and a second paper guide forming a print path, the printer head assembly is mounted along the print path between the first and the second paper guide, wherein a void to the printer module is defined within the housing between the printer head assembly and the first paper guide. The scan module is collapsibly mounted on the housing, the scan module having a scan bar coupling with a multiple original feeder, wherein the scan module is adapted to submerge within the void when it is at a collapsed configuration, and when it is at a lifted configuration, the scan module forms a scan path. The print path is separated from the scan path. A roller assembly is also provided herein.

### FIELD OF THE INVENTION

The present invention generally relates to a multi-function device, and in particular to a compact and mobile integrated printer and scanner device.

### BACKGROUND

A multi-function device (MFD), sometimes also called as a multi-function printer (MFP), can be defined as an office equipment that incorporates the functionality of multiple devices into one physical unit. The device requires smaller footprint compared with having dedicated unit for each different function, while at the same time also offering versatility and affordability.

U.S. Pat. No. 6,898,395 assigned to Hewlett-Packard Development Company, L.P., discloses a multifunction printer apparatus including a printer having a printer media path, and a scanner/stapler assembly detachably secured to the printer. An interlock mechanism is used to engage/disengage scanner/stapler assembly to/from the printer.

The integrated apparatus is bulky and offers limited mobility. The scanner/stapler assembly mounted above the printer requires strong support structure to maintain the bulky construction. The configuration also significantly increases the overall height of the device and does not create an aesthetically integrated look.

U.S. Pat. No. 5,896,206 assigned to Hewlett-Packard Company, discloses a combination of printer and scanner apparatus comprises a frame and plurality of rollers mounted in the frame that define a single paper path through the frame. The apparatus further comprises an automatic sheet feeder, an automatic document feeder, a scanner station, a printer station, a pen door allowing access to the scanner station to permit the cleaning of a scanner window, and a clamping mechanism for removing a jammed print sheet or document.

The apparatus uses a single paper path configuration as it acknowledges that two separated paper paths have disadvantages of cumbersome and complex mechanism for clearing of paper jams and cleaning the scanner window.

However, it is to be noted that a shared paper path for scanning and printing function also has disadvantage of exposing the device to the risk of smearing the original document to be scanned, since it has to pass through the print station along the single shared paper path.

U.S. Pat. No. 5,790,279 assigned to Hewlett-Packard Company, discloses another combined scanner and printer apparatus sharing the same paper feed mechanism. The paper sheets are either passed through the scanner first and then to the printer, or a paper selection switch is provided to select whether the paper in the paper feed mechanism is to be scanned or printed.

The use of partially shared paper path for scanning and printing lowers the risk of smearing, since the original document to be scanned does not pass through the print zone. However, there is still a risk of damaging the original document to be scanned in the event of paper jam.

### SUMMARY OF THE INVENTION

The following presents a simplified summary to provide a basic understanding of the present invention. This summary is not an extensive overview of the invention and is not intended to identify key features of the invention. Rather, it is to present some of the inventive concepts of this invention in a generalized form as a prelude to the detailed description that is to follow.

In one aspect of the present invention, there is provided a multi-function device comprises a housing having a plurality of pivotable panels, wherein the pivotable panels are collapsible on the housing to conform with its surfaces thereon; a printer module having a printer head assembly and a multiple sheet feeder disposed within the housing, the multiple sheet feeder having a first paper guide, a feeder assembly and a second paper guide forming a print path, the printer head assembly is mounted along the print path between the first and the second paper guide, wherein a void to the printer module is defined within the housing between the printer head assembly and the first paper guide; and a scan module collapsibly mounted on the housing, the scan module having a scan bar coupling with a multiple original feeder, wherein the scan module is adapted to submerge within the void when it is at a collapsed configuration, and when it is at a lifted configuration, the scan module forms a scan path. The print path is separated from the scan path.

In accordance with one embodiment, the print path and the scan path are in opposing direction.

In another embodiment, the pivotable panels are used as the first paper guide and second paper guide.

In a further embodiment, the scan module may further comprises an original guide for loading originals to be scanned. The multiple original feeder may also comprise a pick roller and a drive roller. The pick roller operationally picks up originals and feeds to the drive roller, and the drive roller draws the originals over the scan bar for scanning. The drive roller may be adapted to rotate faster than the pick roller. Further, the pick roller may comprise an overdrive clutch.

In another aspect of the present invention, there is provided a roller assembly for a scanner module having a scan bar adapted for scanning originals. The roller assembly comprises a first roller adapted to pick up the originals, the first roller is coupled with a driven gear that operationally receiving a driven force for driving the first roller to rotate; a second roller arranged parallely to the first roller at a close proximity, the second roller receives the originals from the first roller, and draw the originals over the scan bar for carrying out scanning operationally, wherein the second roller is adapted to rotate faster than the first roller; and an overdrive clutch disposed between the first roller and the driven gear, wherein the first roller is driven by the driven gear when the overdrive clutch is engaged, and when the first roller rotates faster than the driven gear, the overdrive clutch disengages the first roller from the driven gear.

In one embodiment, wherein the overdrive clutch may comprise two rotatable parts attached to the first roller and the driven gear respectively, wherein each rotatable part having a protrusion. The overdrive clutch is engaged when the protrusions are in contact with each other, and disengaged when the protrusions are moving away from each other.

The aforementioned roller assembly may be adapted by said multi function device of the present invention.

The objectives and advantages of the present invention will become apparent from the following detailed description of embodiments thereof in connection with the accompanying drawings.

### BRIEF DESCRIPTION OF THE DRAWINGS

Preferred embodiments according to the present invention will now be described with reference to the figures accompanied herein, in which like reference numerals denote like elements.

FIG. 1 illustrates a perspective view of an integrated printed and scanner device according to one embodiment of the present invention;

FIG. 2 illustrates a cross sectional side view of the device shown in FIG. 1 in accordance with one embodiment of the present invention;

FIG. 3 illustrates a perspective view of the device shown in FIG. 1 in a collapsed configuration in accordance with one embodiment of the present invention;

FIG. 4 illustrates a front perspective view of a scanner module of the device shown in FIG. 1 in accordance with one embodiment of the present invention;

FIG. 5 illustrates a rear perspective view of the scanner module shown in FIG. 4 in accordance with one embodiment of the present invention;

FIG. 6 illustrates an overdrive clutch mechanism of the scanner module shown in FIG. 4 in accordance with one embodiment of the present invention when original to be scanned is pushed forward by a pick roller;

FIG. 7 illustrates an overdrive clutch mechanism of the scanner module shown in FIG. 4 in accordance with one embodiment of the present invention when the original to be scanned reaches a drive roller;

FIG. 8 illustrates an overdrive clutch mechanism of the scanner module shown in FIG. 4 in accordance with one embodiment of the present invention when the original to be scanned is pulled by the drive roller;

FIG. 9 illustrates an overdrive clutch mechanism of the scanner module shown in FIG. 4 in accordance with one embodiment of the present invention when the original to be scanned is no longer in contact with the pick roller; and

FIG. 10 illustrates a scanner module configuration of the device shown in FIG. 1 in accordance with one embodiment of the present invention;

### DETAILED DESCRIPTION

Embodiments of the present invention shall now be described in detail, with reference to the attached drawings. It is to be understood that no limitation of the scope of the invention is thereby intended, such alterations and further modifications in the illustrated device, and such further applications of the principles of the invention as illustrated therein being contemplated as would normally occur to one skilled in the art to which the invention relates.

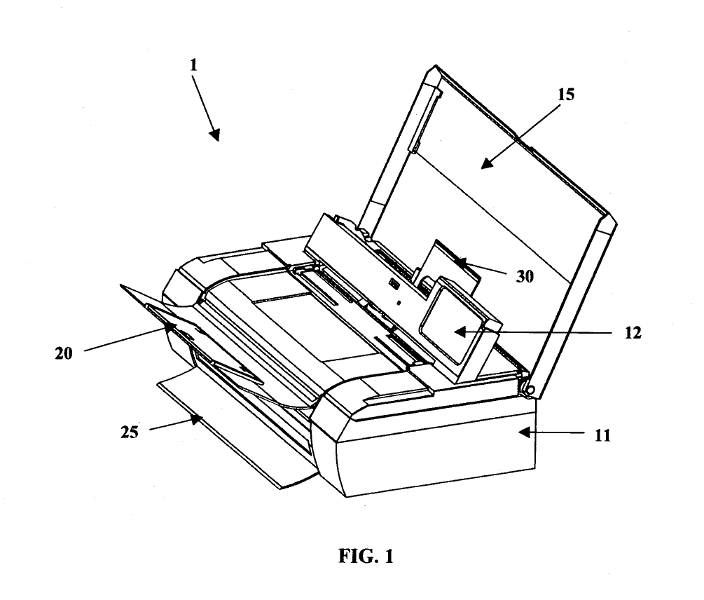

FIG. 1 shows a perspective view of an integrated printer and scanner device 1 in accordance with one embodiment of the present invention. The integrated printer and scanner device 1 is adapted to generally provide printing and scanning features within one compact device. The device 1 comprises a housing 11, a paper input 15 and output guide 25, an original input 20 and output guide 30 and a display panel 12. The input/output sectors (printer and original) are provided for feeding and guiding papers. Generally, paper trays or supports may be provided for supporting and guiding papers.

The paper input guide 15 is collapsibly pivoted along an upper edge of the housing 11 and at the same time forms a lid to a top surface of the housing 11. The display panel 12 is pivotably mounted on the top of the housing 11, at about a quarter length of the top surface from the paper input guide 15. The display panel 12 is pivotably collapsible in a manner opposing the paper input guide 15 on the housing 11.

The display panel 12 is provided for displaying useful information operationally. The display panel 12 is tilted up for visual comfort when operating in both scan and print modes. When the display panel 12 is collapsed, it is embedded in the device 1. The display panel 12 can be a touch screen panel to provide more controls to the device 1.

When the display panel 12 is collapsed towards the housing 11, the paper input guide 15 can also be closed down to hood the components beneath. The display panel 12 comprises a scanner module (not shown in FIG. 1) beneath it for handling originals to be scanned, which includes the original output guide 30, pivoted at a center bottom potion of the display panel 12. The original output guide 30 is collapsible towards the display panel 12. Generally, when the display panel 12 is collapsed into the housing 11, the original output guide 30 is kept butting against the back of the display panel 12. On the other hand, when the display panel 12 is lifted up for use, the original output guide 30 falls away from the display panel 12 as a supporting and guiding tray for the originals. The original output guide 30 also serves as a separator between the originals outputted from the scanner module 10 and papers to be printed on or to be inputted to the printer module 5.

The original input guide 20 is collapsibly pivoted at an opposing upper edge of the housing 11. The original input guide 20 is generally about half-length of the top surface. The original input guide 20 is collapsible toward the top surface of the housing 11. On the other hand, the paper output guide 25 is pivotally mounted along a bottom edge of the housing 11 beneath the original input guide 25. The paper output guide 25 is collapsible to conform to the side surface of the housing 11. A latch may be provided on the paper output guide 25 to keep it butting against the housing 11.

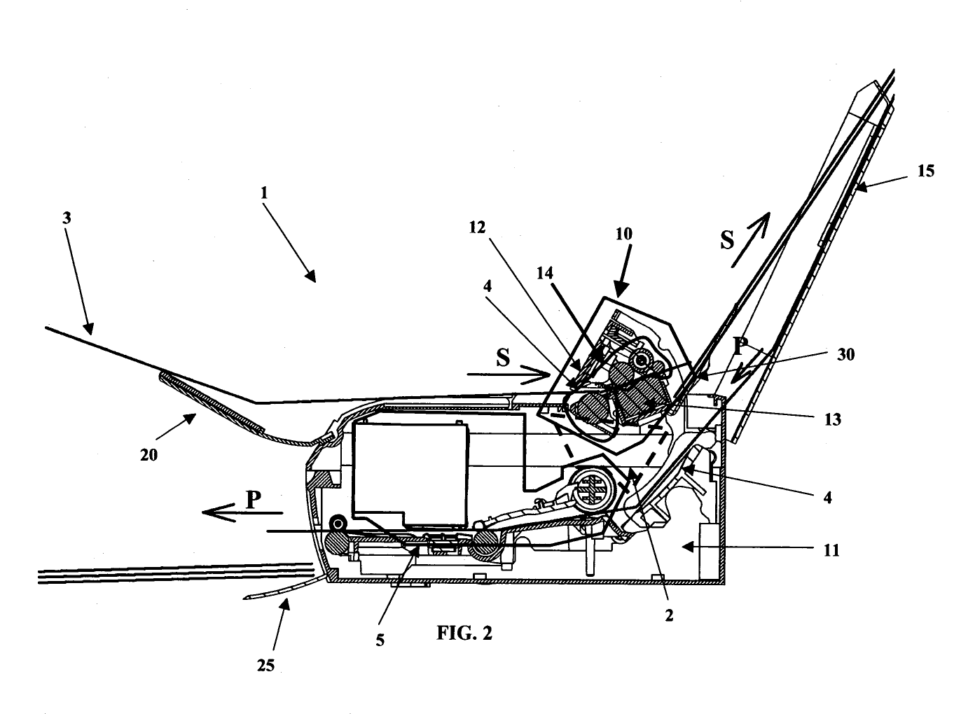

FIG. 2 shows a cross sectional side view of the integrated printer and scanner device 1 in accordance with one embodiment of the invention. The display panel 12 is lifted up together with the scanner module 10 mounted there beneath. A scan path S is formed when the scanner module 10 is lifted up. The scanner module 10 is a multiple-sheet feeding scanner. A slit 4 is defined at the bottom of the display panel 12 for receiving paper sheets. As mentioned, the original output guide 20 is flipped open as a guide and support to the originals. The scan path S starts from the original input guide 20, through the scanner module 10 and ends at the original output guide 30. The scanner module 10 comprises a scan head 13 and a feeder assembly 14 which are adapted in a compact manner to fit within the available space 2 or void within the housing 11.

Typically the space 2 or void is available within the housing due to the mechanism for driving the print head and the paper pick mechanism in the printer module 5. Therefore, integrating the scanner module 10 into the available space 2 optimizes the space usage. The space 2 is used when the scanner module 10 is collapsed on the housing 11 together with the display panel 12 and when it is at a collapsed configuration, the scanning path S is disrupted. When in used, the display panel 12 is lifted up together with the scanner module 10 to form the scanning path S. The scanning path S is entirely separated from the printing path P so that the printing and the scanning can be carried out simultaneously and independently. The collapsible scanner module 10 enables the device 1 to incorporate both printing and scanning functions, while maintaining its compact and integrated form.

When the device 1 is used for scanning, originals 3 are loaded on the original input guide 20 with the display panel 12 lifted up. During the scans, the roller assembly 14 draws each original sheet 3 through the slit 4 and feeds through the scan head 13 to perform scanning. Each scanned original is ejected on the other side of the scan module 10, i.e. to the original output guide 30.

When the device 1 is used for printing, the paper input guide 15 serves as a loading tray for loading paper to be printed. In use, the papers are loaded on the paper input guide 15 for feeding through a printer module 5 mounted within the housing 11. From the paper input guide 15, the papers are fed through the printer module 5 via the print path P and subsequently ejected to the paper output guide 25 located below the original input guide 20.

The paper feeding and printing mechanisms are commonly known in the art. The paper feeding and ejecting process are carried out by sheet feeders mounted within the housing 11. The sheet feeders are adapted to handle papers along the scan path S and the print path P. In the present embodiment, the scan path S and the print path P are two separate and independent paths in an opposing direction. Further it is preferred that the original output guide 30 comprises a flap for preventing the originals 3 drop into the paper input guide 15 after they are being scanned.

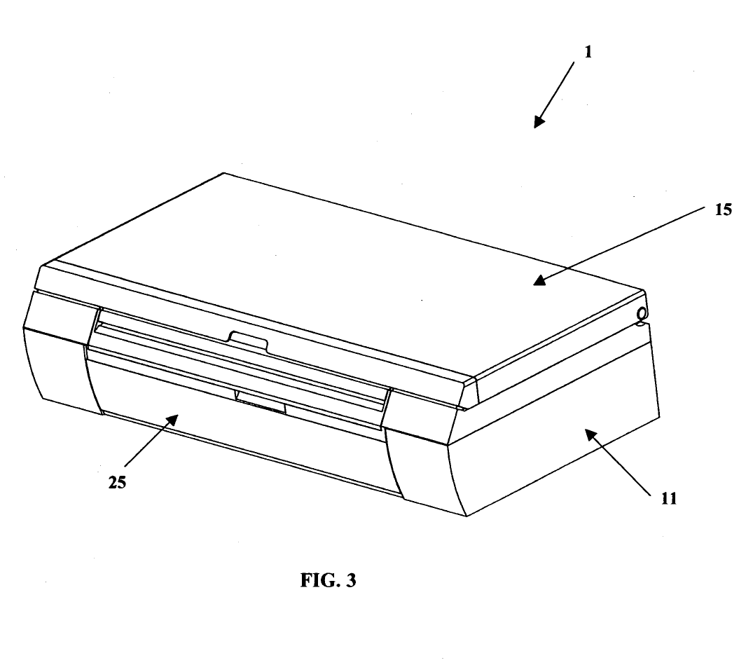

FIG. 3 illustrates the device 1 in a collapsed configuration. In the collapsed configuration, the display panel 12, together with the scanner module 10, are neatly housed within the housing 11. A compact integrated printer and scanner featuring paper feeding can be realized.

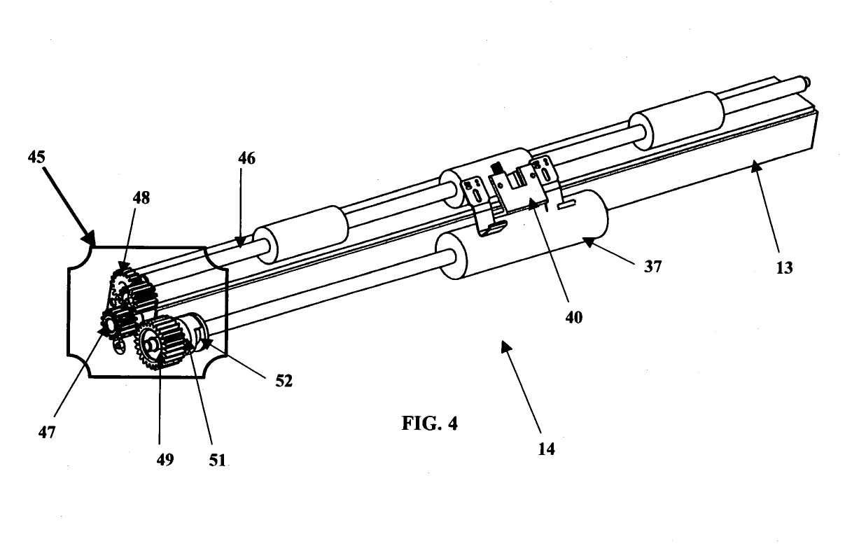

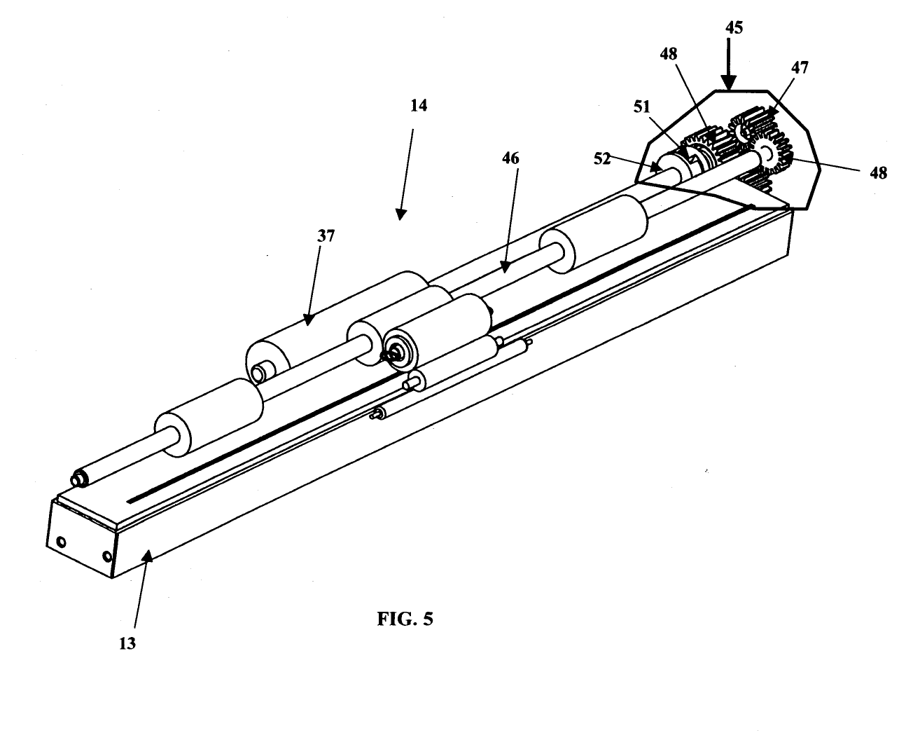

FIGS. 4 and 5 show front and rear perspective views of the scanner module 10 in accordance with one embodiment of the present invention. As mentioned above, the scanner module 10 comprises the feeder assembly 14 and the scan head (not shown). The feeder assembly 14 comprises a pick roller 37, a loading sensor (not shown), a Top of Form sensor (not shown), a separation assembly 40 and a drive roller 46.

The loading sensor is positioned at the front most of the roller assembly 14, at the center, to detect presence of paper sheet. The pick roller 37 is positioned next to the loading sensor to pick up the originals loaded on the original input guide 20. The originals picked up by the pick roller 37 are subjected to separation carried out by the separation assembly 40, such that the originals are fed on a sheet-by-sheet basis. Once separated, the original is conveyed to the drive roller 46.

The Top of Form sensor detects the leading edge of the original to initiate the scanning through the scan head 13, as well as the trailing edge of the original to end the scanning operation. The scan head 13 may be spring loaded to ensure that the original is in contact with the scan head 13 as much as possible and to provide smooth conveyance of the original.

Ideally, in the present embodiment, the drive roller 46 and the pick roller 37 are to rotate in a same speed. However, it is understood that such identical speed is generally hard to achieve. Any slight variations (faster or slower) in speed between the rollers would affect the scan operations, thereby the quality and accuracy of the scanned images. Therefore, in one embodiment of the present invention, the roller assembly 14 further comprises an overdrive clutch mechanism 45 adapted to compensate the speed variations. The overdrive clutch mechanism 45 is provided to address speed inconsistency between the rollers, in particular, the pick roller 37 and the drive roller 46. The overdrive clutch mechanism 45 comprises a connecting gear 47, a drive roller gear 48 and a pick roller gear 49. The drive roller gear 48 and the pick roller gear 49 are coupled to the corresponding drive roller 46 and pick roller 37 respectively. The drive roller gear 48 is directly coupled with the connecting gear 47, which at the same time is engaged with the pick roller gear 49 to transmit rotation.

The overdrive clutch mechanism 45 is adapted to the pick roller 37. It comprises a clutch having two rotating parts 51 and 52, i.e. one 51 is driven by the pick roller gear 49, and the other 52 is provided to drive the pick roller 37. Each rotating part has a coupling engagement member for coupling with the other. The coupling engagement members can simply be two opposing protrusions defined on the parts 51 and 52 in one embodiment of the present invention. The two parts 51, 52 are disengaged when the protrusions are apart/away from one another, and engaged when the protrusions are in contact. When the two protrusions are disengaged, the pick roller 37 is rotatable freely and not driven by the pick roller gear 39. When the two protrusions are engaged, the pick roller 37 is driven by the pick roller gear 49.

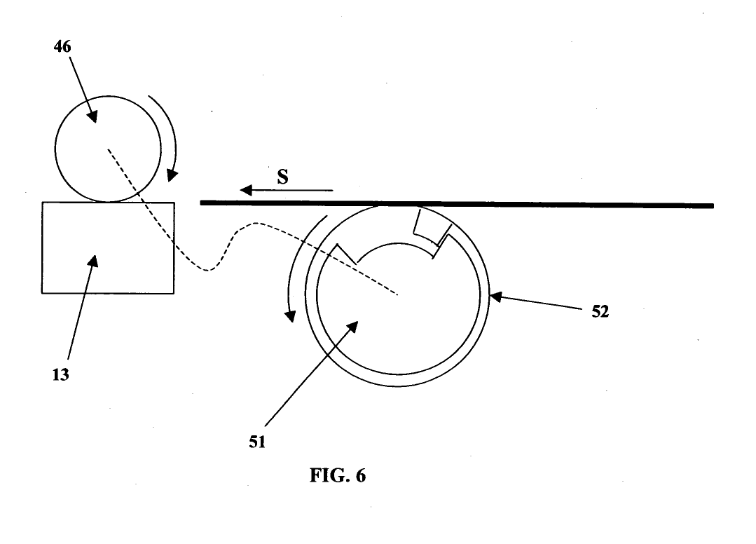

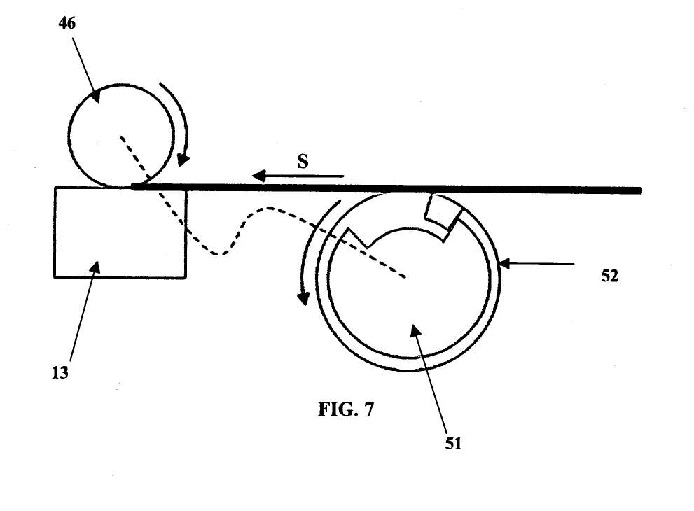

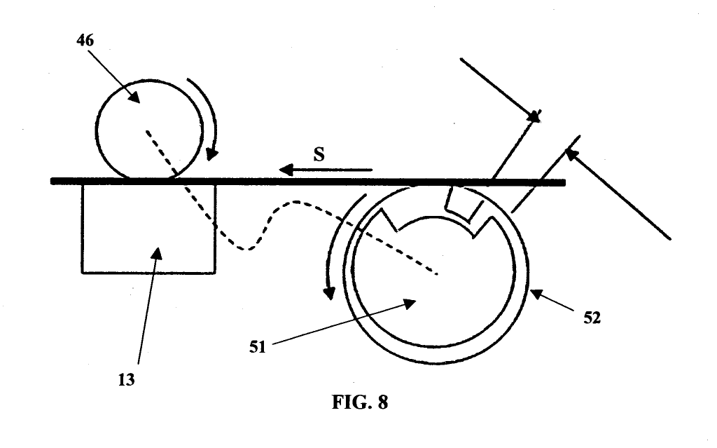

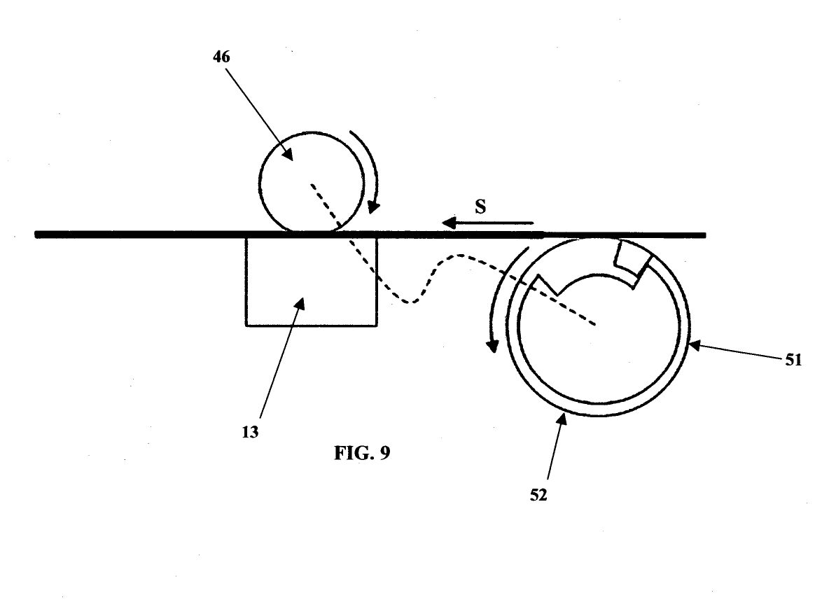

FIGS. 6-9 show schematically operations of the overdrive clutch mechanism 45 of FIG. 5. FIG. 6 shows when the original is fed into the scanner module 10 and pushed forward by the pick roller 37; FIG. 7 shows when the original reaches the drive roller 46; FIG. 8 shows when the original is pulled by the drive roller 46 and FIG. 9 shows when the original is no longer in contact with the pick roller 37 respectively.

Specifically, the overdrive clutch mechanism 45 is designed such that the drive roller 46 rotates faster than the pick roller 37, i.e. overdrive. When the pick roller 37 is rotated independently, the two parts 51, 52 are engaged with each other, and the rotation of part 51 drives the part 52 to rotate (see FIG. 6). An original fed thereon is moving at the same speed as the pick roller 37 driven by the pick roller gear 49. When the original reaches the drive roller 46 (see FIG. 7), as the pick roller 37 is slower than the drive roller 46, the original drags the pick roller 37 to rotate at the same speed as the drive roller 47 through the original. As the pick roller 37 rotates faster than it was, the part 52 also rotates faster than part 51 resulting in the disengagement between the parts 51 and 52 (see FIG. 8).

As the trailing edge of the original leaves the pick roller 37 (see FIG. 9), the drag effect is no longer present; the pick roller 37 slows down or stops to rotate, which allows the part 51 to catch up. Once the part 51 catches up and engages with the part 52 again, the pick roller 37 is driven by the part 51 at the same speed again and await the next original to be fed in. The overdrive clutch mechanism 45 provides a compensation in rotating speed between the pick roller 37 and the drive roller 46 ensuring that the paper feeding between the pick roller 27 and the drive roller 46 is smooth, thereby preventing any undesired scans, such as jagged image.

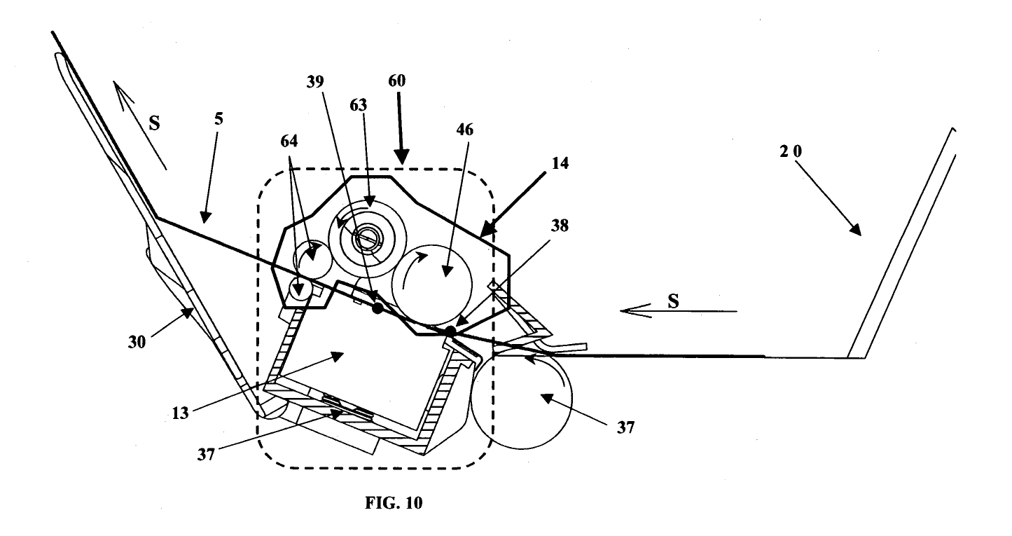

FIG. 10 shows the configuration of the scan module 10 feeding a scanning mechanism through the scan path S. Firstly, the original to be scanned 5 is loaded in the original input guide 20. Next, the document to be scanned is transferred to the scan zone 60 by mean of the feeder assembly 14, which passes through the scan head 13. In one embodiment of the present invention, a scan bar is used for line scanning. The feeder assembly 14 started with the pick roller 37. Followed by the drive roller 46. The drive roller 46 is pressing against the scanner head 13 for scanning the originals on thereon. Once the scanning process is completed, the scanned original 3 is then discharged to the original output guide 30 through the cooperation of output rollers 64. The output rollers 64 are driven by the connecting roller 63 by means of surface contact. The scan head 13 may further comprise a spring 61, such that the originals 3 can be conveyed smoothly throughout the scanning process. There may further provide a Top of Form sensor 39.

While specific embodiments have been described and illustrated, it is understood that many changes, modifications, variations and combinations thereof could be made to the present invention without departing from the scope of the invention.

1. A multi-function device comprising:
a housing having a plurality of pivotable panels, wherein the pivotable panels are collapsible on the housing to conform with its surfaces thereon;
a printer module having a printer head assembly and a multiple sheet feeder disposed within the housing, the multiple sheet feeder having a first paper guide, a feeder assembly and a second paper guide forming a print path, the printer head assembly is mounted along the print path between the first and the second paper guide, wherein a void to the printer module is defined within the housing between the printer head assembly and the first paper guide; and
a scan module collapsibly mounted on the housing, the scan module having a scan bar coupling with a multiple original feeder, wherein the scan module is adapted to submerge within the void when it is at a collapsed configuration, and when it is at a lifted configuration, the scan module forms a scan path,
wherein the print path is separated from the scan path.

2. A device according to claim 1, wherein the print path and the scan path are in opposing direction.

3. A device according to claim 1, wherein the pivotable panels are used as the first paper guide and second paper guide.

4. A device according to claim 1, wherein the scan module further comprises an original guide for loading originals to be scanned.

5. A device according to claim 1, wherein the multiple original feeder comprises a pick roller and a drive roller, wherein the pick roller operationally picks up originals and feeds to the drive roller, and the drive roller draws the originals over the scan bar for scanning.

6. A device according to claim 5, wherein the drive roller is adapted to rotate faster than the pick roller.

7. A device according to claim 5, wherein the pick roller comprises an overdrive clutch.

8. A roller assembly for a scanner module having a scan bar adapted for scanning originals, the roller assembly comprising:
a first roller adapted to pick up the originals, the first roller is coupled with a driven gear that operationally receiving a driven force for driving the first roller to rotate;
a second roller arranged parallely to the first roller at a close proximity, the second roller receives the originals from the first roller, and draw the originals over the scan bar for carrying out scanning operationally, wherein the second roller is adapted to rotate faster than the first roller; and
an overdrive clutch disposed between the first roller and the driven gear, wherein the first roller is driven by the driven gear when the overdrive clutch is engaged, and when the first roller rotates faster than the driven gear, the overdrive clutch disengages the first roller from the driven gear.

9. A roller assembly according to claim 8, wherein the overdrive clutch comprises two rotatable parts attached to the first roller and the driven gear respectively, wherein each rotatable part having a protrusion, wherein the overdrive clutch is engaged when the protrusions are in contact with each other, and disengaged when the protrusions are moving away from each other.

10. (canceled)

11. A device according to claim 1, wherein the scan module comprises a roller assembly, comprising
a first roller adapted to pick up the originals, the first roller is coupled with a driven gear that operationally receiving a driven force for driving the first roller to rotate;
a second roller arranged parallely to the first roller at a close proximity, the second roller receives the originals from the first roller, and draw the originals over the scan bar for carrying out scanning operationally, wherein the second roller is adapted to rotate faster than the first roller; and
an overdrive clutch disposed between the first roller and the driven gear, wherein the first roller is driven by the driven gear when the overdrive clutch is engaged, and when the first roller rotates faster than the driven gear, the overdrive clutch disengages the first roller from the driven gear.

12. A device according to claim 11, wherein the overdrive clutch comprises two rotatable parts attached to the first roller and the driven gear respectively, wherein each rotatable part having a protrusion, wherein the overdrive clutch is engaged when the protrusions are in contact with each other, and disengaged when the protrusions are moving away from each other.
